(19) United States
(12) Patent Application Publication
(10) Pub. No.: US 2005/0094182 A1
(43) Pub. Date: May 5, 2005

(54) Printer access control

(76) Inventors: Curtis Reese, Boise, ID (US); Mark M. Josephsen, Boise, ID (US); Shane Konsella, Star, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/700,205

(22) Filed: Nov. 3, 2003

(51) Int. Cl. G06F 15/00

(52) U.S. Cl. 358/1.14

(57) ABSTRACT

A printer access control module within a printer receives a request from a client computer for printing resource authorization, determines the policy domain of the requesting client computer, and grants printing resource authorization based on the determined policy domain. A security key is issued to the client to identify the client computer to the printer for confirming granted resource authorization.

### FIELD OF THE INVENTION

The invention relates generally to secure printing, and more specifically to a printer having restricted printer access capability.

### BACKGROUND OF THE INVENTION

Printers typically print a document received from an attached computer upon receipt of the digital information representing the document to be printed. Multiple users may be electronically attached to the same printer via a network, so that a single printer is used by several people. In some environments, printers can receive data to be printed by other means also, including via a wireless or infrared network rather than via a wired network.

When several users or computer systems share access to a single printer, each user configures a printer object for each printer to be used. The user then typically has unlimited and unrestricted access to the printer and to all of its functions and capabilities. This system works adequately for environments in which a small number of responsible users share a single printer, but becomes less effective when a large number of users share a larger number of printers including printers with relatively expensive features such as color printing or high speed and capacity. This configuration, typical of large local-area network systems as are found in business and educational environments, can result in undesired overuse or abuse of color printing, high-capacity printing, and other such printing resources.

One solution is to restrict network access to such printers to only those users who have been preapproved for use of the resources provided by each printer. This method effectively prevents a user from printing very large volumes of pages unnecessarily and from printing color pages if printing in color is not deemed necessary, but requires preapproval and system configuration to grant access to the printers. This delay in approval or authorization may not be desirable in circumstances where a user needs to use the resources immediately and is a legitimate user, such as when a previously authorized user begins to use a new computer or is using a computer other than that user's primary system on the network.

There exists a need for a printer resource authorization management system that addresses these and other problems.

### SUMMARY OF THE INVENTION

In one example embodiment of the invention, a printer access control module within a printer receives a request from a client computer for printing resource authorization, determines the policy domain of the requesting client computer, and grants printing resource authorization based on the determined policy domain. In a further embodiment, a security key is issued to the client to identify the client computer to the printer for confirming granted resource authorization.

### BRIEF DESCRIPTION OF THE FIGURES

FIG. 1 shows a printer and attached computer system consistent with one embodiment of the present invention.

FIG. 2 is a flowchart illustrating a method of practicing one embodiment of the present invention.

### DETAILED DESCRIPTIONS

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the scope of the present invention. The following detailed description is, therefore, not to be taken in a limiting sense, and the scope of the invention is defined only by the appended claims.

The present invention provides a printer system that in some embodiments is operable to receive a request from a client computer for printing resource authorization, determine the policy domain of the requesting client computer, and grant printing resource authorization based on the determined policy domain. In a further embodiment, a security key is issued to the client to identify the client computer to the printer for confirming granted resource authorization.

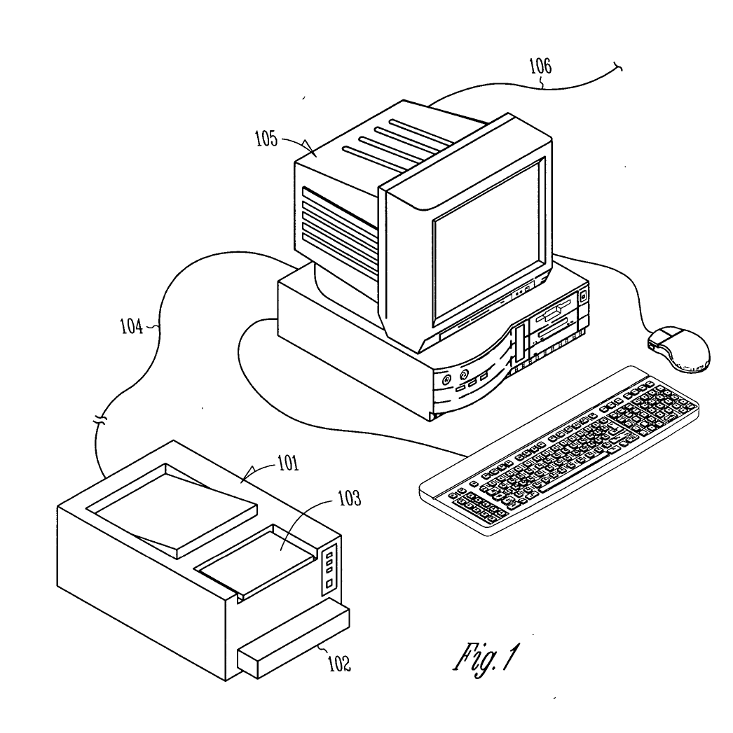

FIG. 1 shows an example system upon which some embodiments of the present invention may be practiced. A printer device 101 prints received data on paper or other media for physically recording the data. The typical laser printer illustrated here, for example, processes paper from paper tray 102 and deposits toner from toner cartridge 103 on the paper to create a physical record of the data to be printed. Various other printers include inkjet, dye sublimation, and ribbon impact marking technology, and print on various media such as transparencies, envelopes, and photographic paper.

The printer 101 is here connected via connection 104 to a computerized system 105. The connection 104 in various embodiments of the invention comprises any of various types of connection operable to provide communication between the computer and printer, including parallel (IEEE 1284), Universal Serial Bus (USB), firewire (IEEE 1384), ethernet, and other such connections. The computerized system is further attached to a network such as network 106, and is employed by a user, who wishes access to the printer 101 for printing data.

In operation, the user of the computerized system 105 desires to print a document using printer 101. The client computer is not registered with the printer or otherwise authorized to use some or all of the various resources of the printer, and so requests authorization to use at least some of the various printing resources of the printer. The printer 101 receives the authorization request form computer 105 via network connection 104, and determines the policy domain of the user. This is achieved in some embodiments of the invention by determining whether the network IP address of the user's computer 105 falls within a certain predefined network address range or ranges. Other embodiments will use other user information to determine whether the user is part of a specific policy domain, including looking up the user's user identification or group memberships in the network environment, determining the physical location of the user or user's computer 105, or making other such determinations of user characteristics.

The printer determines whether the user is a member of the policy domain in one embodiment of the invention via a printer access control module executing within the printer. In one specific embodiment, the printer access control module is a Java program running in a Java virtual machine environment within the 101 printer's digital logic circuitry. This functionality enables the printer to determine the user's membership in the policy domain, and to selectively grant the user access to various printer resources in response.

Once the user has been granted access to the various printer resources based on policy domain membership, the user is able to print to the printer and to use the printer's resources up to any limits on resource usage that are imposed. In some embodiments of the invention, limited printer resource usage may be granted to all users, with greater resource access granted to users who are members of specific policy domains. For example, a user whose computer is not located in the marketing department and who is not a member of management may be granted full access to a printer's black-and-white print capability, but have limited access to its color printing capability.

Printer resources comprise in various embodiments any identifiable resource of the printer that may be used in printing a document. This includes not only common resources such as paper, toner, and ink, but also includes all other resources available to the printer, such as printer memory or hard disk space. A variety of other such printer resources are restricted in various embodiments of the invention, including restricting use of color, restricting use of transparencies or other special media, limiting the number of pages that can be printed in a single print job, limiting the cost of pages printed over a period of time, limiting the number of pages printed over a period of time, or limiting the cost per printed page.

In some further embodiments of the invention, the user authenticates identity to the printer by using a security or encryption key, which the printer uses to confirm identity and authorization for users. The security key is in some embodiments issued and managed by a security module within the printer, as is described in the copending patent application titled “Printer Security Key Management”, filed which is hereby incorporated by reference. The security key issued to each user in such an embodiment of the invention is therefore usable not only to ensure secure communication of data between the user and a printer, but to authenticate the user's identity to the printer for granting access to printer resources.

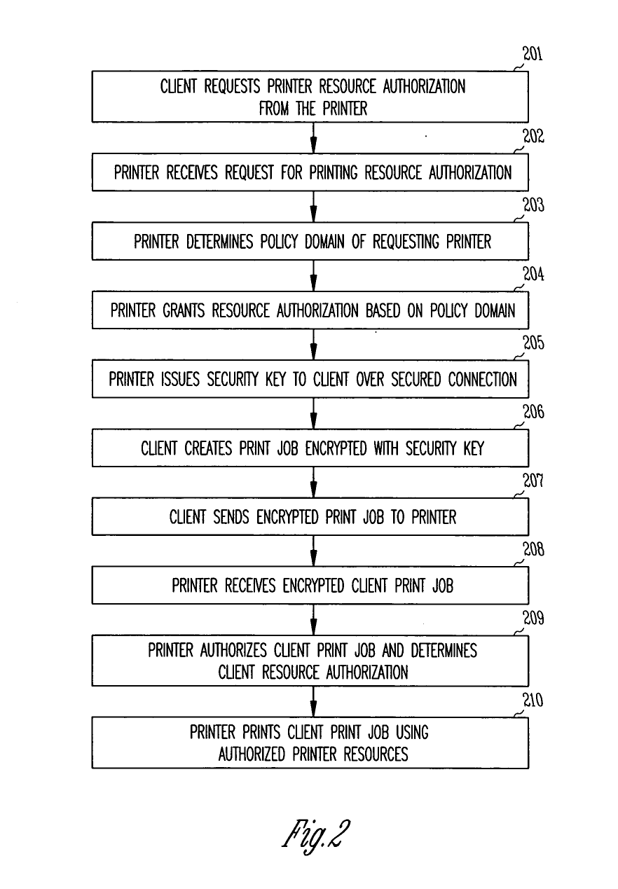

The flowchart of FIG. 2 illustrates in greater detail how one such embodiment of the present invention operates. At 201, a client requests printing resource authorization from an attached printer. In this example, the printer and the client computer are both attached to the same network, and the printer is a network device that is visible to network users. The printer receives the request for printing resource authorization at 202, and determines the policy domain of the requesting client computer system at 203.

Based on the policy domain determination, the printer grants certain predetermined printing resource authorization at 204. The printer grants this authorization by creating a security key or keys associated with the client computer, and issues a security key to the client computer at 205.

The keys are created in this example embodiment by a security module within the printer that is executing as a Java application within a Java virtual machine. In one embodiment, a symmetric key is generated, and the symmetric key is transmitted to the attached computer requesting the key only after a secure connection has been negotiated between the printer and the client computer. This ensures the confidentiality of the symmetric key, which can be used to encrypt data or to decrypt data that has already been encrypted with the same symmetric key. A wide variety of algorithms using symmetric keys or block ciphers, including DES (Data Encryption Standard), IDEA, CAST, Twofish, Blowfish, MD5, and RC5, may be employed in this manner in various embodiments to ensure the identity of the client and the confidentiality of data between the client system and the printer.

In other embodiments of the invention, asymmetric algorithms may be employed, such as the public key/private key RSA system. In the public key/private key systems, the printer security module generates both a public and a private key. It retains the private key, and sends the public key to the client computer system. The public key can be used to encrypt data sent to the printer, but cannot be used to decrypt the encrypted data. This means that if the public key is sent to the requesting user of the client system over an insecure link, the person intercepting the public key cannot decrypt data cannot use the key to decrypt data sent from the client system to the printer, but could only encrypt data sent to the printer as though he were the authorized user of the public key.

When the printer receives the data encrypted by the public key, it decrypts it using the private key, and either prints the data or stores the data until the user indicates he is ready for the data to be printed. Storing the data until the user confirms it is to be printed is useful in applications where a single printer is shared among many users or is located in a relatively public place. The user can then identify himself to the printer such as by entering a pin number, password, biometric, or other identifier, and cause the document to print when he is at the printer and able to ensure the physical security of the printed data.

After receiving the security key, the client computer can then create a print job and use the key to encrypt the print job at 206. The encrypted print job is then sent to the printer at 207, and the printer receives the print job at 208. The printer authenticates the user at 209 by decrypting the print job, thereby verifying that it was encrypted and produced by the user or client having the corresponding security key, and determines the client's resource authorization.

The decrypted print job is then printed at 210. In some embodiments of the invention, the print job will be printed with characteristics specific to the client's resource authorization or identified policy domain. As an example, a printer printing a color document who has not been granted color printing resource authorization may still send a color print job to the printer, but the print job will be printed in black and white. A variety of other such limitations on a user or client's printer resource authorization may similarly be used to modify the characteristics of a print job within the printer, all of which are within the scope of the present invention.

The system presented here does not require a central key management authority, even for embodiments that use a public key/private key encryption algorithm, because the printer acts as its own trusted key management authority. Incorporation of key production and management functions into a security module within the printer provides a simpler system of key management, and a web browser-based interface to the security module provides users with a user-friendly friendly interface to perform key management functions. Further embodiments of the invention will provide a variety of key management functions, including the ability to create, assign, delete, group, or otherwise manage the keys and users as is deemed appropriate for a particular application.

Although specific embodiments of a printer resource access control system have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A printer access control module within a printer that is operable to:
receive a request from a client computer for printing resource authorization;
determine the policy domain of the requesting client computer; and
grant printing resource authorization based on the determined policy domain.

2. The printer access control module of claim 1, wherein granting printing resource authorization comprises granting full printing resource authorization to client computers that are members of the policy domain and granting limited printing resource authorization to client computers that are not members of the policy domain.

3. The printer access control module of claim 1, wherein granting printing resource authorization comprises granting greater printing resource authorization to client computers that are members of the policy domain than to client computers that are not members of the policy domain

4. The printer access control module of claim 1, wherein the printing resource comprises color printing.

5. The printer access control module of claim 1, wherein the printing resource comprises high-volume printing comprising print jobs over a specified page limit.

6. The printer access control module of claim 1, wherein the printing resource comprises specific print media, specific print media comprising at least one of letterhead, check stock, glossy paper, and transparencies.

7. The printer access control module of claim 1, wherein the printing resource comprises at least one of a maximum cost per page, maximum cost per period of time, and maximum pages per period of time.

8. The printer access control module of claim 1, wherein the policy domain comprises a predefined portion of network node addresses on a local area network

9. The printer access control module of claim 1, wherein the policy domain comprises a predefined group of identifiable users.

10. The printer access control module of claim 1, wherein the policy domain comprises network nodes possessing a printer security key

11. The printer access control module of claim 1, wherein granting printing resource authorization based on the determined policy domain comprises issuing the client computer a printer security key that identifies the client computer to the printer.

12. The printer access control module of claim 11, wherein the security key is used with each print job to identify the client's granted printer resource authorization to the printer.

13. A printer that is operable to:
receive a request from a client computer for printing resource authorization;
determine the policy domain of the requesting client computer; and
grant printing resource authorization based on the determined policy domain.

14. The printer of claim 13, wherein granting printing resource authorization comprises granting full printing resource authorization to client computers that are members of the policy domain and granting limited printing resource authorization to client computers that are not members of the policy domain.

15. The printer of claim 13, wherein granting printing resource authorization comprises granting greater printing resource authorization to client computers that are members of the policy domain than to client computers that are not members of the policy domain

16. The printer of claim 13, wherein the printing resource comprises color printing.

17. The printer of claim 13, wherein the printing resource comprises high-volume printing comprising print jobs over a specified page limit.

18. The printer of claim 13, wherein the printing resource comprises specific print media, specific print media comprising at least one of letterhead, check stock, glossy paper, and transparencies.

19. The printer of claim 13, wherein the printing resource comprises at least one of a maximum cost per page, maximum cost per period of time, and maximum pages per period of time.

20. The printer of claim 13, wherein the policy domain comprises a predefined portion of network node addresses on a local area network

21. The printer of claim 13, wherein the policy domain comprises a predefined group of identifiable users.

22. The printer of claim 13, wherein the policy domain comprises network nodes possessing a printer security key

23. The printer of claim 13, wherein granting printing resource authorization based on the determined policy domain comprises issuing the client computer a printer security key that identifies the client computer to the printer.

24. The printer access control module of claim 23, wherein the security key is used with each print job to identify the client's granted printer resource authorization to the printer.

25. A machine-readable medium with instructions stored thereon, the instructions when executed on a computerized system operable to cause the system to:
receive a request from a client computer for printing resource authorization;
determine the policy domain of the requesting client computer; and
grant printing resource authorization based on the determined policy domain.

26. The machine-readable medium of claim 25, wherein granting printing resource authorization comprises granting full printing resource authorization to client computers that are members of the policy domain and granting limited printing resource authorization to client computers that are not members of the policy domain.

27. The machine-readable medium of claim 25, wherein granting printing resource authorization comprises granting greater printing resource authorization to client computers that are members of the policy domain than to client computers that are not members of the policy domain

28. The machine-readable medium of claim 25, wherein the printing resource comprises color printing.

29. The machine-readable medium of claim 25, wherein the printing resource comprises high-volume printing comprising print jobs over a specified page limit.

30. The machine-readable medium of claim 25, wherein the printing resource comprises specific print media, specific print media comprising at least one of letterhead, check stock, glossy paper, and transparencies.

31. The machine-readable medium of claim 25, wherein the printing resource comprises at least one of a maximum cost per page, maximum cost per period of time, and maximum pages per period of time.

32. The machine-readable medium of claim 25, wherein the policy domain comprises a predefined portion of network node addresses on a local area network.

33. The machine-readable medium of claim 25, wherein the policy domain comprises a predefined group of identifiable users.

34. The machine-readable medium of claim 1, wherein the policy domain comprises network nodes possessing a printer security key

35. The machine-readable medium of claim 25, wherein granting printing resource authorization based on the determined policy domain comprises issuing the client computer a printer security key that identifies the client computer to the printer.

36. The machine-readable medium of claim 35, wherein the security key is used with each print job to identify the client's granted printer resource authorization to the printer.
